(19) United States
(12) Patent Application Publication
(10) Pub. No.: US 2016/0091937 A1
(43) Pub. Date: Mar. 31, 2016

(54) HEAT DISSIPATION STRUCTURE FOR HAND-HELD DEVICE

(71) Applicant: Asia Vital Components Co., Ltd., New Taipei City (TW)

(72) Inventors: Ching-Hang Shen, New Taipei City (TW); Chun-Min Wu, New Taipei City (TW)

(21) Appl. No.: 14/497,329

(22) Filed: Sep. 26, 2014

(51) Int. Cl. G06F 1/20

(52) U.S. Cl. CPC G06F 1/203

(57) ABSTRACT

A heat dissipation structure for hand-held device includes an element holding member internally defining a receiving space, a base plate held in the receiving space and having a plurality of electronic elements mounted on a top thereof, at least one heat conductive layer provided on one side of the electronic elements opposite to the base plate, and a graphite layer provided on one side of the heat conductive layer opposite to the electronic elements. The heat conductive layer transfers heat produced by the electronic elements to the graphite layer, from where the heat is quickly dissipated into ambient air, enabling upgraded heat dissipation efficiency of the electronic elements.

### FIELD OF THE INVENTION

The present invention relates to a heat dissipation structure for hand-held device, and more particularly to a heat dissipation structure for hand-held device designed to increase the heat dissipation efficiency of electronic elements in a hand-held device.

### BACKGROUND OF THE INVENTION

Most of the currently available hand-held devices, such as notebook computers, tablet computers and smartphones, have a slim body and a largely increased computing speed. The electronic elements in the hand-held devices for executing the computation at high speed also produce a large amount of heat during operation thereof. For the purpose of being conveniently portable, the hand-held devices have a largely reduced overall thickness. And, to prevent invasion by foreign matters and moisture, the hand-held devices are provided with only an earphone port and some necessary connection ports but not other open holes that allow air convection between the narrow internal space of the hand-held devices and the external environment. Therefore, due to the small thickness of the hand-held devices, the large amount of heat produced by the electronic elements in the hand-held devices, such as the computation executing units and the battery, can not be quickly dissipated into the external environment. Further, due to the closed narrow internal space of the hand-held devices, it is difficult for the heat produced by the electronic elements to dissipate through air convection. As a result, heat tends to accumulate or gather in the hand-held devices to adversely affect the working efficiency or even cause crash of the hand-held devices.

To solve the above problems, some passive type heat dissipation elements, such as heat spreader, vapor chamber, heat sink, etc., are mounted in the hand-held devices to assist in heat dissipation thereof. Due to the small thickness and the narrow internal space of the hand-held devices, these passive type heat dissipation elements must also be extremely thin to be mounted in the very limited internal space of the hand-held devices. However, the wick structure and the vapor passage in the size reduced heat spreader and vapor chamber are also reduced in size to result in largely lowered heat transfer efficiency of the heat spreader and the vapor chamber and accordingly, poor heat dissipation performance thereof. In brief, when the internal computing units of the hand-held devices have an extremely high power, the conventional heat spreader and vapor chambers just could not effectively dissipate the heat produced by the high power computing units.

In view that the hand-held devices have a narrow internal space and have a plurality of electronic elements densely mounted in the narrow space, and the heat produced by the electronic elements during operation tends to accumulate in the narrow receiving space of the hand-held devices without being easily transferred to an outer side of the hand-held devices for dissipation, it is obviously important to work out a way for effectively removing the heat from the narrow internal space of the hand-held devices

### SUMMARY OF THE INVENTION

A primary object of the present invention is to provide a heat dissipation structure for hand-held device to overcome the drawbacks in the prior art. To achieve the above and other objects, the heat dissipation structure for hand-held device according to the present invention includes an element holding member internally defining a receiving space, a base plate held in the receiving space and having a plurality of electronic elements mounted on a top thereof, at least one heat conductive layer provided on one side of the electronic elements opposite to the base plate, and a graphite layer provided on one side of the heat conductive layer opposite to the electronic elements. The heat conductive layer transfers heat produced by the electronic elements to the graphite layer, from where the heat is quickly dissipated into ambient air, enabling upgraded heat dissipation efficiency of the electronic elements.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a heat dissipation structure for hand-held device according to a first embodiment of the present invention;

FIG. 2 is an assembled sectional view of the heat dissipation structure for hand-held device according to the first embodiment of the present invention;

FIG. 3 is an assembled sectional view of a heat dissipation structure for hand-held device according to a second embodiment of the present invention; and

FIG. 4 is an assembled sectional view of a heat dissipation structure for hand-held device according to a third embodiment of the present invention.

### DETAILED DESCRIPTION OF THE PREFERRED EMBODIMENTS

The present invention will now be described with some preferred embodiments thereof and by referring to the accompanying drawings. For the purpose of easy to understand, elements that are the same in the preferred embodiments are denoted by the same reference numerals.

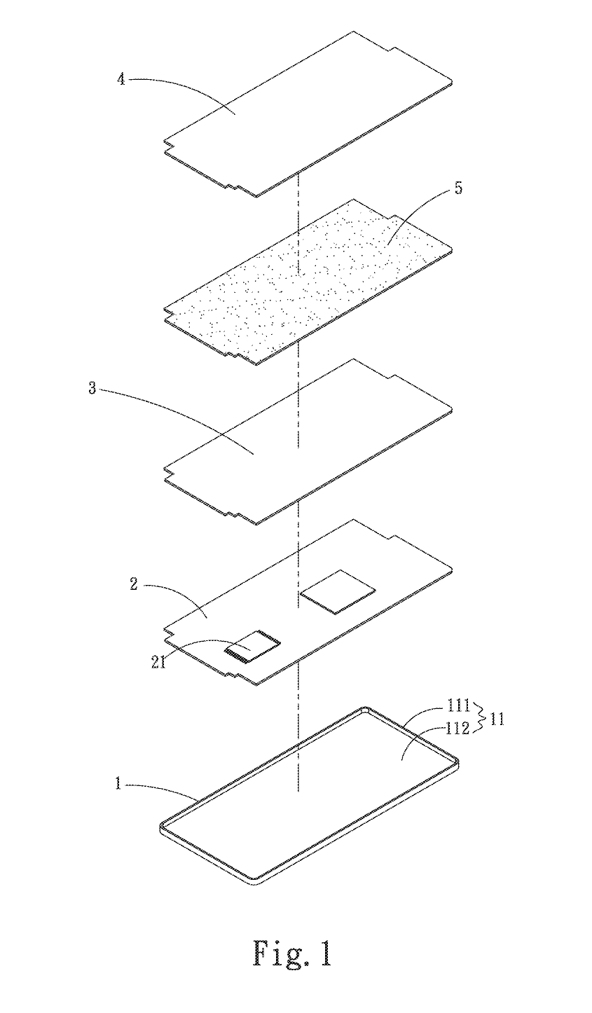

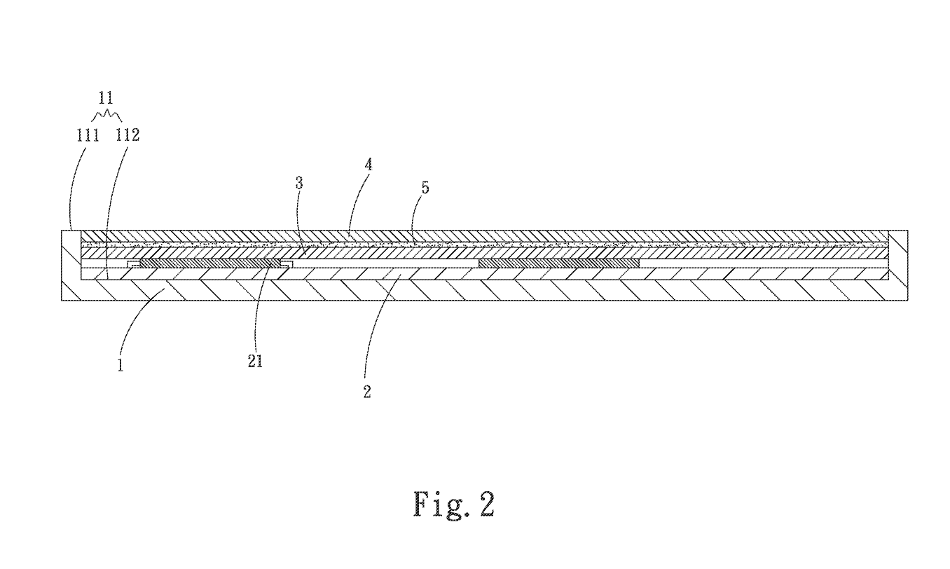

Please refer to FIGS. 1 and 2, which are exploded perspective and assembled sectional views, respectively, of a heat dissipation structure for hand-held device according to a first embodiment of the present invention. As shown, the heat dissipation structure for hand-held device includes an element holding member 1.

The element holding member 1 internally defines a receiving space 11 for holding a base plate 2 therein. The base plate 2 can be a substrate or a circuit board, and has a plurality of electronic elements 21 mounted on a top thereof. At least one heat conductive layer 3 is provided on one side of the electronic elements 21 opposite to the base plate 2. The heat conductive layer 3 is formed of a good heat conductor, which can be copper, aluminum, gold, silver, stainless steel or any other metal material with high heat conductivity. In the illustrated first embodiment, the heat conductive layer 3 is formed of copper foil. A graphite layer 4 is provided on one side of the heat conductive layer 3 opposite to the electronic elements 21. The graphite layer 4 can be formed of a graphite sheet or a graphene film. The heat conductive layer 3 and the graphite layer 4 are joined together by bonding, sputtering deposition, welding, laminating, or mechanical processing, such as high-pressure and high-temperature pressing. In the illustrated first embodiment, the heat conductive layer 3 and the graphite layer 4 are bonded together via an adhesive layer 5 provided between them. The element holding member 1 can be made of a metal sheet, such as an aluminum sheet, an aluminum-copper alloy sheet or a stainless steel sheet; or other sheets formed through power metallurgy or plastic molding. The electronic elements 21 can be a central processing unit or a microcontroller (MCU). The adhesive layer 5 can be an adhesive agent, a thermal paste or any other material that provides a bonding effect.

The receiving space 11 defined in the element holding member 1 has an open side 111 and an opposite closed side 112. The base plate 2 is held in the receiving space 11 with a bottom in contact with the closed side 112; and the electronic elements 21 mounted on the top of the base plate 2 has one side oriented to the open side 111 of the receiving space 11. The side of each of the electronic elements 21 oriented to the open side 111 of the receiving space 11 is a free end surface, above which the heat conductive layer 3 is provided. In the illustrated first embodiment, the base plate 2 is attached at the bottom to the closed side 112 of the receiving space 11, and the electronic elements 21 are located in the receiving space 11 with the heat conductive layer 3 provided above their free end surfaces. The adhesive layer 5 and the graphite layer 4 are sequentially provided on one side of the heat conductive layer 3 opposite to the electronic elements 21. All of the heat conductive layer 3, the adhesive layer 5 and the graphite layer 4 are received in the receiving space 11 with the graphite layer 4 being horizontally extended to flush with the open side 111. By providing the heat conductive layer 3 and the graphite layer 4, heat produced by the electronic elements 21 in the receiving space 11 can be more quickly transferred via the heat conductive layer 3 to the graphite layer 4 and be dissipated into ambient air from the graphite layer 4 to achieve the effect of quick heat transfer, spreading and dissipation.

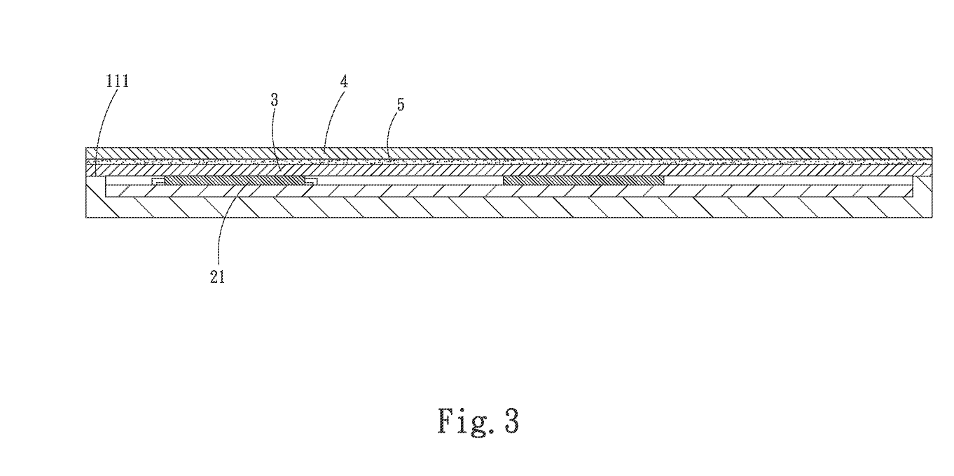

FIG. 3 is an assembled sectional view of a heat dissipation structure for hand-held device according to a second embodiment of the present invention. As shown, the second embodiment is generally structurally similar to the first embodiment, except that, in the second embodiment, the free end surfaces of the electronic elements 21 are horizontally extended to flush with the open side 111 of the receiving space 11. The heat conductive layer 3 is then provided above the free end surfaces of the electronic elements 21, and the adhesive layer 5 and the graphite layer 4 are sequentially provided on one side of the heat conductive layer 3 opposite to the electronic elements 21. With these arrangements, the heat produced by the electronic elements 21 in the receiving space 11 can be more quickly transferred via the heat conductive layer 3 to the graphite layer 4 and be dissipated into ambient air from the graphite layer 4 to achieve the effect of quick heat transfer, spreading and dissipation.

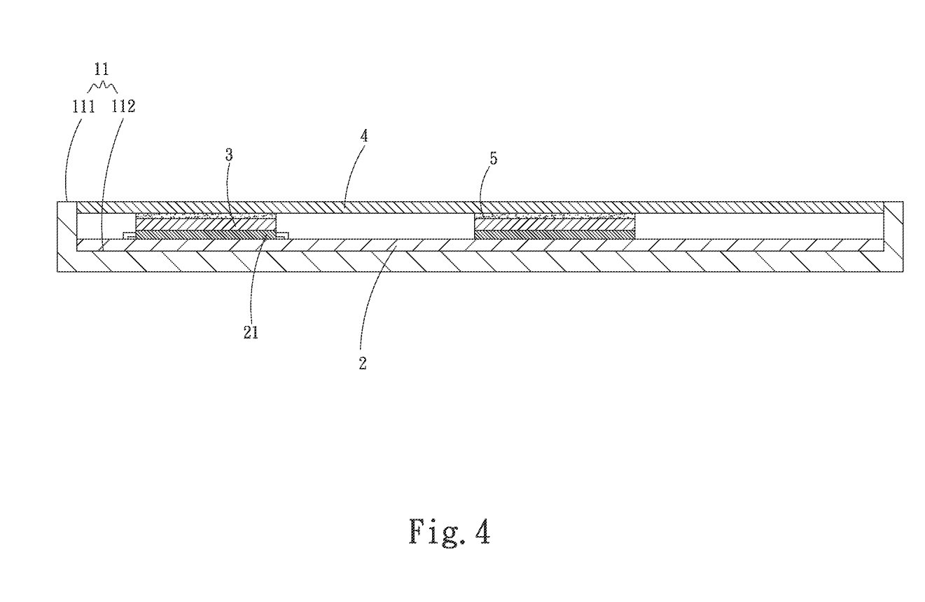

FIG. 4 is an assembled sectional view of a heat dissipation structure for hand-held device according to a third embodiment of the present invention. As shown, the third embodiment is generally structurally similar to the first embodiment, that is, the base plate 2 is attached at the bottom to the closed side 112 of the receiving space 11, and the electronic elements 21 are located in the receiving space 11 with the heat conductive layer 3 provided above them. However, in the third embodiment, the heat conductive layer 3 is provided only on the free end surfaces of the electronic element 21. That is, the heat conductive layer 3 has a total area equal to that of the free end surfaces of the electronic elements 21. Then, the adhesive layer 5 and the graphite layer 4 are sequentially provided on one side of the heat conductive layer 3 opposite to the electronic elements 21. All of the heat conductive layer 3, the adhesive layer 5 and the graphite layer 4 are received in the receiving space 11 with the graphite layer 4 being horizontally extended to flush with the open side 111. By providing the heat conductive layer 3 and the graphite layer 4, the heat produced by the electronic elements 21 in the receiving space 11 can be more quickly transferred via the heat conductive layer 3 to the graphite layer 4 and be dissipated into ambient air from the graphite layer 4 to achieve the effect of quick heat transfer, spreading and dissipation.

In view that the heat produced by the electronic elements 21 mounted in the hand-held device tends to accumulated in the narrow and closed internal space of the hand-held device to cause damage to the hand-held device, the present invention is provided mainly to solve the heat dissipation problem of the hand-held device. By providing the heat conductive layer 3, which has good radiation heat transfer effect, on the free end surface of each electronic element 21 in the hand-held device, the electronic element 21 can have largely increased heat transfer efficiency; and, by providing the graphite layer 4, the heat produced by the electronic elements 21 and transferred via the heat conductive layer 3 to the graphite layer 4 can be absorbed by the graphite layer 4 and then be quickly dissipated from the graphite layer 4 into ambient air to effectively achieve heat dissipation and avoid accumulation of the produced heat in the hand-held device.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A heat dissipation structure for hand-held device, comprising an element holding member internally defining a receiving space, a base plate held in the receiving space and having a plurality of electronic elements mounted on a top thereof, at least one heat conductive layer provided on one side of the electronic elements opposite to the base plate, and a graphite layer provided on one side of the heat conductive layer opposite to the electronic elements.

2. The heat dissipation structure for hand-held device as claimed in claim 1, wherein the heat conductive layer is formed of a heat conductor selected from the group consisting of copper, aluminum, gold, silver, stainless steel and any other metal material of high heat conductivity.

3. The heat dissipation structure for hand-held device as claimed in claim 1, wherein the heat conductive layer is formed of copper foil.

4. The heat dissipation structure for hand-held device as claimed in claim 1, further comprising an adhesive layer provided between the heat conductive layer and the graphite layer.

5. The heat dissipation structure for hand-held device as claimed in claim 4, wherein the adhesive layer is selected from the group consisting of an adhesive agent, a thermal paste, and any other material that provides a bonding effect.

6. The heat dissipation structure for hand-held device as claimed in claim 1, wherein the element holding member is made of a sheet material selected from the group consisting of an aluminum sheet, an aluminum-copper alloy sheet, a stainless steel sheet, a power metallurgy sheet and a plastic molded sheet.

7. The heat dissipation structure for hand-held device as claimed in claim 1, wherein the receiving space defined in the element holding member has an open side and an opposite closed side; the base plate being held in the receiving space with a bottom in contact with the closed side; and the electronic elements mounted on the top of the base plate having one side oriented to the open side of the receiving space; the side of each of the electronic elements oriented to the open side of the receiving space being a free end surface, and the heat conductive layer being provided above the free end surfaces of the electronic elements.

8. The heat dissipation structure for hand-held device as claimed in claim 1, wherein the graphite layer is provided on the heat conductive layer in a manner selected from the group consisting of bonding, sputtering deposition, mechanical processing, welding, and laminating.
